(19) United States
(12) Patent Application Publication
(10) Pub. No.: US 2014/0201616 A1
(43) Pub. Date: Jul. 17, 2014

(54) CROSS-PLATFORM EMBEDDABLE MEDIA PLAYER

(71) Applicant: SUBSPLASH, INC., Seattle, WA (US)

(72) Inventors: Timothy J. E. Turner, Seattle, WA (US); Justin Atrim Jenkins, Seattle, WA (US)

(21) Appl. No.: 13/839,037

(22) Filed: Mar. 15, 2013

Related U.S. Application Data
(60) Provisional application No. 61/752,346, filed on Jan. 14, 2013.

(51) Int. Cl. G06F 17/22

(52) U.S. Cl. CPC G06F 17/2247
USPC 715/234

(57) ABSTRACT

Technology is described for enabling a cross-platform media player. The technology can provide a script to be added to a Web page; receive from a client computing device a request for content; identify content to be provided to the client computing device, the identifying based at least on a type of a Web browser from which the request was received; and provide a markup to be added to the Web page. The markup added to the Web page does not cause the Web page to be reloaded. Each URL specifying content can be globally unique.

### CROSS-REFERENCE TO RELATED APPLICATION

This patent application claims the benefit of commonly assigned U.S. Provisional Patent Application Ser. No. 61/752,346, entitled “CROSS-PLATFORM EMBEDDABLE MEDIA PLAYER” and filed on Jan. 14, 2013, which is incorporated herein in its entirety by reference.

### BACKGROUND

With the increasing bandwidth and content download speeds available to Internet users, Web site operators are increasingly using multimedia content on their Web sites. Examples of multimedia content include, e.g., audio, video, audio/video, etc. Moreover, because of the increased reliance on Web sites to propagate information from individuals, businesses, and other organizations, Web site operators continue to seek content authoring and content management tools that require minimal or even no technical knowledge, e.g., computer programming language and/or Web design skills.

Although various content authoring and content management tools already exist, most require some technical proficiency to add content to Web sites—especially if the content needs to be available across operating system, browser, and device platforms or architectures. As an example, some Web sites employ conventional plug-ins, e.g., ADOBE FLASH, to render multi-media. However, Web site operators who do this commonly have to use Javascript or other script code that executes within a Web browser (“client-side script”) to select the correct version of a plug-in, e.g., based on the operating system, browser, and even version of the browser. Moreover, when multiple types of content are employed by a Web site, the script code needs to select an appropriate plug-in that is capable of rendering selected media. As an example, the Web site may need to provide a FLASH plug-in to render audio/video, but a different plug-in to render navigational content. As another example, a Web site operator may desire their Web site to be viewable across a broad array of users. However, users employing an APPLE IPAD may be unable to view content designed for ADOBE FLASH, but a user employing a MICROSOFT WINDOWS device may be unable to view content designed for APPLE QUICKTIME.

### BRIEF DESCRIPTION OF THE DRAWINGS

FIG. 1 is a block diagram illustrating an environment in which the disclosed technology operates in various embodiments.

FIG. 2 is a code diagram illustrating portions of hypertext markup language employed by the disclosed technology in various embodiments.

FIG. 3 is a flow diagram illustrating a routine invoked by the disclosed technology in various embodiments.

FIG. 4 is a flow diagram illustrating a routine invoked by the disclosed technology in various embodiments.

FIG. 5 is a user interface diagram illustrating a user interface of a Web site employing the disclosed technology in various embodiments.

FIG. 6 is a table diagram illustrating a table employed by the disclosed technology in various embodiments.

FIG. 7 is a block diagram illustrating components of a computing system employed by the disclosed technology in various embodiments.

### DETAILED DESCRIPTION

Technology is disclosed for enabling Web site operators to embed a cross-platform/cross-browser media presentation software without requiring significant technical expertise. In various embodiments, a Web browser based media presentation software application (“the software”) is embedded into an existing 3rd party (e.g., stand-alone) Web page (“container Web page”) via simple Javascript and HTML (hypertext markup language, e.g., HTML version 5) code (“embed code”) that seamlessly adds and modifies—possibly based on user interaction—the content and uniform resource locator (URL) of the Web page with information and data from a remote system for the purposes of presenting interactive and navigable media content. Media content can include various “elements,” e.g., lists, video, audio, audio/video, artwork, images, text, social and interactive elements independent of and not originally hosted on the container Web page and are inserted into the container Web page without conflicting with the container Web page's styles and or template. The content can be inserted into a defined area of the container Web page or may override the entire presentation of the container Web page based on the platform of the browser client software.

In various embodiments, the software is not a conventional plug-in that that is loaded into a Web page. Instead, it is embedded software that is embedded in a container Web page that dynamically (e.g., at the time the Web page is loaded or rendered) modifies the content of the container Web page. The software can provide an internally-referenced navigable media experience with elements, e.g., as pages, lists, items, and other objects with which the Web site's users can interact. Users can navigate elements within the Web page and/or elements rendered by the software, and the software can respond by modifying the container Web page's content, e.g., with information from a remote content source. Additionally, the software can adjust the URL of the container Web page to create a unique, standard URL that the software can later use to modify the content of the container Web page, e.g., to facilitate loading, reloading, using standard browser navigation and history features, sharing, bookmarking, indexing by search engines, or otherwise navigating to content.

The URLs the software creates can be encoded with various information. The encoded information can be employed by a server computing device, e.g., to determine what content is to be returned upon receiving a requested URL. The encoded information can also be employed by a client-side component, e.g., script executed by the client's browser, to dynamically modify the container Web page. In various embodiments, the script executed by the client's browser can request multiple content elements based on the information encoded in a URL. Because the software dynamically manipulates the content of the Web page, the user can interact with the Web page as if it was all originating from the container Web page. This benefits users by enabling them to follow links to or from bookmarks, email, social networking, etc. In contrast, links used for dynamic modification at the client usually “break” when Web site operators employ conventional techniques.

A Web site operator embeds some HTML and a link (e.g., a URL) to one or more Javascript files. The Web site operator may have received this information electronically, e.g., in an electronic mail message, or other conventional communication. Web site operators are typically sufficiently familiar with content authoring tools to copy and paste simple HTML, links and Javascript tags. As an example, Web site operators desiring to employ the disclosed technology can be provided the following HTML and Javascript code to insert into a Web page, e.g., a Web page in which the disclosed technology is to operate:

<div id=“scp-root”>&nbsp;</div>
<script type=“text/javascript” language=“javascript”>
// <![CDATA[

var _APP = “CHURCH”;
var _KEY = “ed4876bdc2a65bd3dec29107fdacd4aa”;

// ]]>
</script>
<script type=“text/javascript” language=“javascript”
src=“http://embed.subsplash.com/js/current.js”></script>

The inserted HTML adds a DIV section with identifier “scp-root.” As is known in the art, other identifiers can be substituted. The script that executes in the browser can reference the identified DIV section, e.g., to add HTML (or other) tags or other content before, within, or after the identified DIV section.

The inserted HTML also adds an application identifier (“CHURCH”, here) and a key (e.g., a sequence of alphanumeric and/or symbolic characters that may be globally unique) within a data section of a script tag. The script that executes in the browser can provide the application identifier and the key to a Web server from which it requests content. The server may determine which content to provide (and whether the Web site is authorized to employ the content) based on a combination of the Web site's URL, the application identifier, the key, and the application identifier. In various embodiments, the key may be a globally unique identifier.

The inserted HTML also adds a link to a script, e.g., a script expressed in the Javascript language. As is known in the art, other scripting languages can be employed. When a browser loads the Web page is loaded, the browser may execute the linked script. The script can retrieve the current URL (e.g., the URL of the container Web page) and parse the URL to retrieve a “hash.” A hash is a string (e.g., a combination of letters, numbers, and/or symbols) that can be added to a URL without violating the Internet requirements for URLs. If a hash is present, the hash may indicate (e.g., be encoded with) an entity identifier and a type. The script transmits the entity identifier and the type to a server computing device, e.g., a “Subsplash” content server. The script may transmit this information using an AJAX invocation. AJAX is an Internet technique used to asynchronously exchange data between software executing at computing devices, e.g., browsers and Web servers. The hash can be used to uniquely identify the Web page.

Upon receiving the entity identifier and optionally the type, code executing at the content server (e.g., the Subsplash content server) can retrieve the identified entity, e.g., from a database or a file, optionally confirm that the retrieved entity has the same type as the identified entity, and return the entity, e.g., in a JSON or JSONP data format, to the browser. Entities can be content (“endpoint”) or lists of other entities. The endpoints can be any type of content, e.g., text, image, video, audio, navigation elements (e.g., expressed in HTML or other language), etc. Entities can also indicate additional entities that may also be subsequently requested by the browser. In various embodiments, the code executing at the server determines what content to provide based on an analysis of information the browser transmits, e.g., header information indicating an operating system, browser type, browser version, etc.

The script executing at the browser may receive a response from the server in the JSON and/or JSONP format. JSON (“Javascript Object Notation”) is a commonly employed format for exchanging data between Internet servers and clients. JSONP is similar to JSON, but also includes “padding,” e.g., a prefix. JSONP can be employed to inject script into a Web page, e.g., within a script element. Because script tags do not respect a browser's “same origin policy,” which can cause browsers to display warnings or errors when content is retrieved from multiple Web sites or different Web “domains,” a Web site employing the disclosed technology can insert the provided HTML to retrieve content from Subsplash content server easily without confusing users. The data the server returns (e.g., in JSON or JSONP format) can include content (e.g., endpoints) or lists of other entities. If the data indicates content, the script retrieves the indicated content and determines how to render it. The determination can be based on the operating system, browser type, browser version, and availability of software or hardware components best capable of rendering the received content. Rendering the content may include emitting HTML and/or script, e.g., to display images, navigation elements, multimedia content in a player appropriate for the content, etc. The emitted HTML and/or script can include both information from a template and information specific to the content to be rendered. As an example, when an image is to be rendered, the template information can include an HTML IMAGE tag and the specific information can identify a URL from which the image is to be retrieved. The browser can add the emitted HTML and/or script to the container Web page without causing the container Web page to be reloaded (or “refreshed”).

When a user selects a link on a Web page, the browser repeats these steps. If a hash is not present in the current URL, the script may employ a default hash or indicate to the content server that no hash is available so that the server can provide default content.

In various embodiments, the technology can specify or override cascading styles, e.g., so that styles specified for other elements on the Web page do not cause unintended behavior for elements added by the script. As an example, additional styles may be emitted before or within the DIV section added by the Web site operator.

Several embodiments of the described technology are described in more detail in reference to the Figures. The computing devices (e.g., client computing devices and/or server computing devices) on which the described technology may be implemented may include one or more central processing units, memory, input devices (e.g., keyboard and pointing devices), output devices (e.g., display devices), storage devices (e.g., disk drives), and network devices (e.g., network interfaces). The memory and storage devices are computer-readable storage media, e.g., non-transitory media, that may store instructions that implement at least portions of the described technology. In addition, the data structures and message structures may be stored or transmitted via computer-readable media, e.g., a data transmission medium, such as a signal on a communications link, or other transitory media. Various communications links may be used, such as the Internet, a local area network, a wide area network, or a point-to-point dial-up connection.

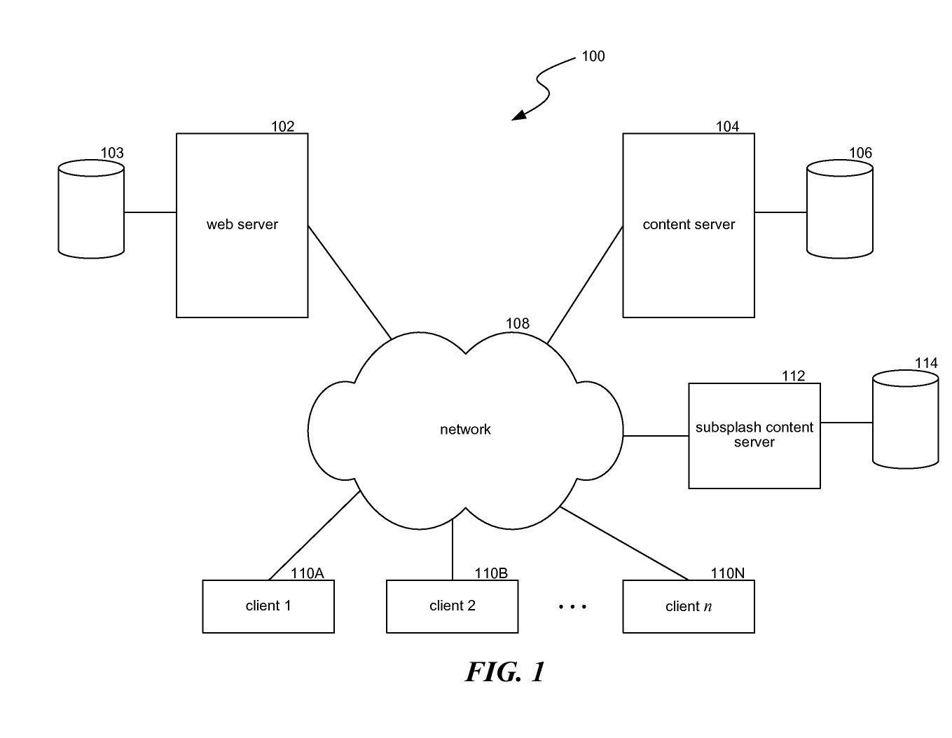

FIG. 1 is a block diagram illustrating an environment 100 in which the disclosed technology operates in various embodiments. The environment 100 includes a Web server 102, and a database 103 associated with the Web server 102. The Web server 102 can provide content via a network 108 to one or more client computing devices 110 A., 110 B., and 110 N. The environment 100 also includes a content server 104 having an associated database 106. The content server 104 can provide content via the network 108, e.g., to the Web server 102 and/or the client computing devices 110 A, 110 B, and 110 N. The environment 100 can also include a Subsplash content server 112 having an associated database 114. In various embodiments, the content server 104 and a Subsplash content server 112 can be combined into a single server (not illustrated).

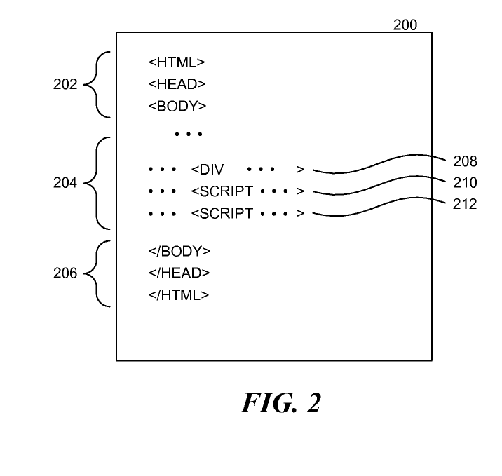

FIG. 2 is a code diagram illustrating portions of hypertext markup language employed by the disclosed technology in various embodiments. A Web page 200 served by a Web server associated with a Web server provider can include existing HTML sections 202 and 206. When the Web server operator elects to employ the disclosed technology, the operator may add HTML section 204, e.g., upon receiving instructions via email or other communications, by simply copying it from the communications and pasting it into an existing HTML Web page. The HTML section 204 can include a DIV section 208, a first script section 210, and a second script section 212. The first script section 210 can be a data section, e.g., as section indicating an application identifier and a key. The second script section 212 can link to a script file, e.g., a JavaScript file located at a Subsplash content server.

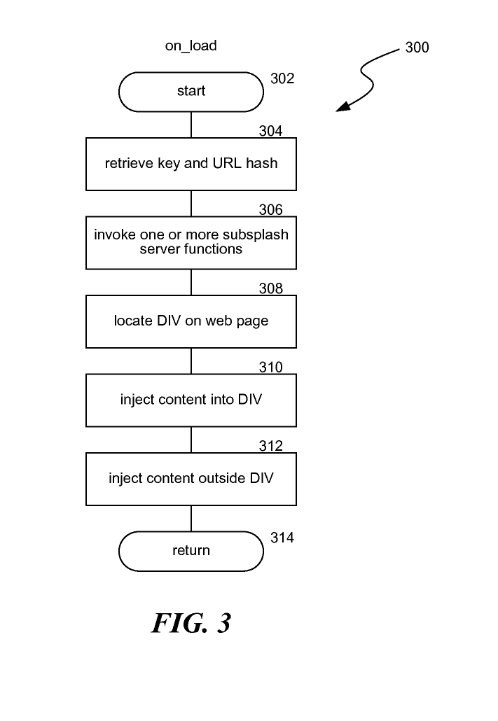

FIG. 3 is a flow diagram illustrating a routine 300 invoked by the disclosed technology in various embodiments, e.g., at a browser when a Web page loads. The routine 300 begins at block 302. At block 304, the routine retrieves a key and a URL hash. In various embodiments, the routine may retrieve the key, provide the key to a Web server, and then retrieve the hash upon receiving instructions from the Web server. The routine then continues at block 306, where it invokes one or more Subsplash content server functions. As an example, the routine may invoke AJAX functions to retrieve content for the Web page. At block 308, the routine locates the DIV section described above. At block 310 the routine injects content within the DIV section. At block 312, the routine injects content outside the DIV section, e.g., before and/or after the DIV section. The routine then returns at block 314.

Those skilled in the art will appreciate that the logic illustrated in FIG. 3 and described above, and in each of the flow diagrams discussed below, may be altered in a variety of ways. For example, the order of the logic may be rearranged, substeps may be performed in parallel, illustrated logic may be omitted, other logic may be included, etc.

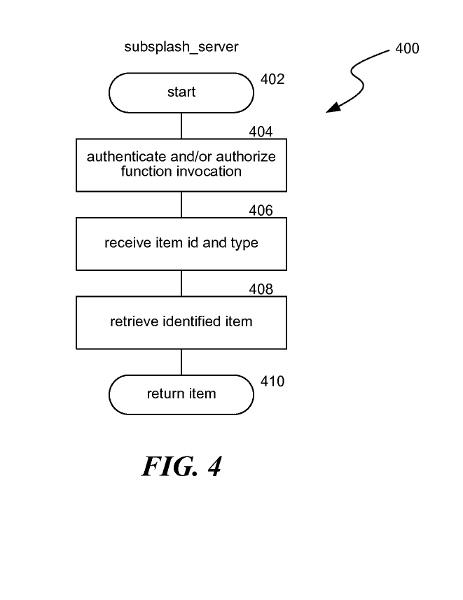

FIG. 4 is a flow diagram illustrating a routine 400 invoked by the disclosed technology in various embodiments, e.g., at a Subsplash content server upon receiving a request from a browser to invoke a function. The routine begins at block 402. At block 404, the routine authenticates and/or authorizes indication of the function. As examples, the routine may employ a URL associated with a Web server from which the browser retrieved the Web page, an application identifier, a key, etc. This information may be provided by the browser when it invokes a function. At block 406, the routine receives an item identifier and a type, e.g., within the function indication. At block 408, the routine retrieves the identified item, e.g., from a database. The routine may optionally confirm that the retrieved item is of the same type as the type indicated in the request (not illustrated). The routine then returns the retrieved item at block 410. In various embodiments, the item can be an endpoint or a list of items. An endpoint can specify content to be rendered at the browser. A retrieved item can identify additional items to be retrieved.

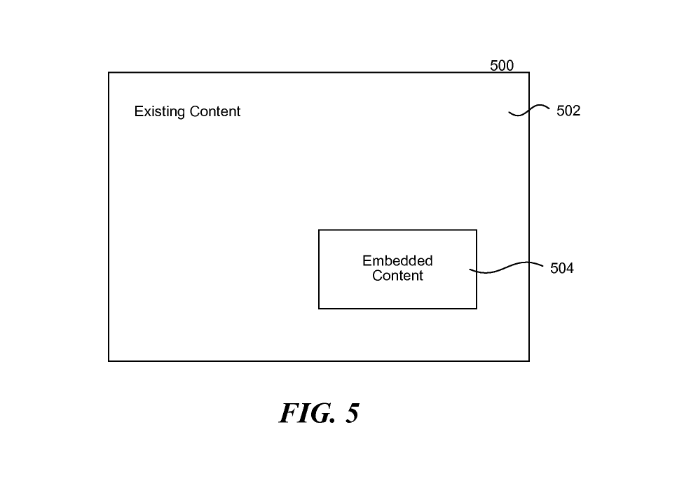

FIG. 5 is a user interface diagram illustrating a user interface 500 of a Web page employing the disclosed technology in various embodiments. The user interface can include existing content 502 and embedded content 504. The embedded content can be emitted, e.g., by script executing within a browser, upon receiving HTML or script from the Subsplash content server. By inserting and modifying content dynamically, the disclosed technology causes a Web page to operate as a Web site of many different Web pages.

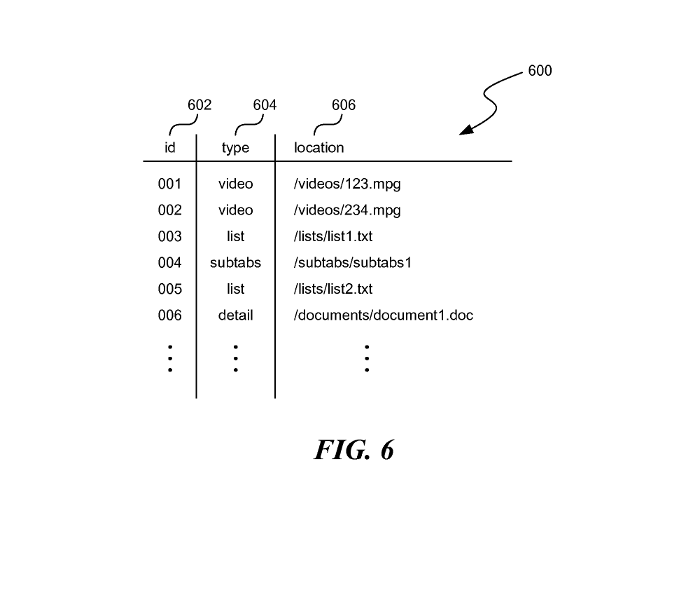

FIG. 6 is a table diagram illustrating a table 600 employed by the disclosed technology in various embodiments. The table can include an identifier column 602, a type column 604, and a location column 606. The identifier column 602 corresponds to identifiers of items that may be returned to clients upon receiving requests for content. The location column 606 corresponds to locations of items, e.g., in a filesystem. In various embodiments, the location column may also or instead specify locations within a database. While FIG. 6 illustrates a table whose contents and organization are designed to make them more comprehensible by a human reader, those skilled in the art will appreciate that actual data structures used by the facility to store this information may differ from the table shown, in that they, for example, may be organized in a different manner; may contain more or less information than shown; may be compressed and/or encrypted; etc.

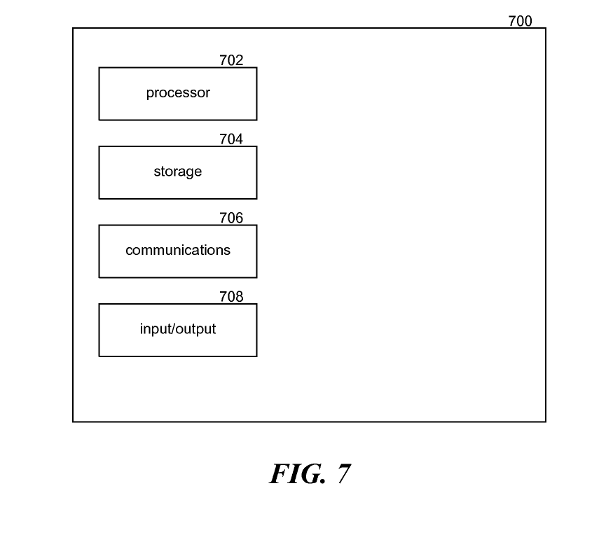

FIG. 7 is a block diagram illustrating components 700 of a computing system employed by the disclosed technology in various embodiments. The components can include a processor (e.g., a central processing unit) 702, a storage 704, a communications component 706, and input/output component 708. The storage 704 can include primary and/or secondary storage. The communications component 706 is capable of communicating with other computing devices, e.g., via a wireless or other network. The input/output component 708 can receive input, e.g., from a user via an input device, or provide output, e.g., via a screen or other output device.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. Accordingly, the invention is not limited except as by the appended claims.

I/we claim:

1. A method performed by a server computing device, comprising:
providing a script to be added to a Web page;
receiving from a client computing device a request for content;
identifying content to be provided to the client computing device, the identifying based at least on a type of a Web browser from which the request was received; and
providing a markup to be added to the Web page wherein the markup is added to the Web page without causing the Web page to be reloaded, and wherein adding the markup causes the Web browser to retrieve and render the requested content.

2. The method of claim 1, wherein the provided markup is unaffected by conflicting cascading styles.

3. The method of claim 1, further comprising authorizing transfer of the content based at least on an identifier received with the request for content.

4. The method of claim 1, further comprising providing only a list of content as a response to the request for content.

5. The method of claim 1, further comprising identifying additional content the client computing device should request upon receiving the requested content.

6. The method of claim 1, wherein the markup is provided in a JSON data format or a JSONP data format.

7. A method performed by a client computing device, comprising:
retrieving a hash from a uniform resource locator identified as a Web page currently navigated to;
identifying an entity identifier and a type in the hash;
requesting from a server computing device content specified by at least the identifier and the type identified in the hash;
receiving from the server computing device a markup;
emitting the received markup within the currently navigated-to Web page without reloading the Web page;
receiving from the server computing device the requested content;
determining how to render the received content; and
rendering the received content.

8. The method of claim 7, wherein the request is transmitted using an AJAX technique.

9. The method of claim 7, wherein the markup is received in a JSON data format or a JSONP data format.

10. The method of claim 7, further comprising identifying a software component capable of rendering the received content and causing the identified software component to render the received content.

11. The method of claim 7, wherein the received content is a navigation element.

12. The method of claim 7, wherein the hash uniquely identifies the Web page.
